(19) United States
(12) Patent Application Publication
(10) Pub. No.: US 2016/0309826 A1
(43) Pub. Date: Oct. 27, 2016

(54) HELMET LIGHT BAR AND SAFETY LIGHT SYSTEM INCLUDING SAME

(71) Applicants: RC ANDERSON, LA MESA, CA (US); KENNETH J. LONG, LA MESA, CA (US)

(72) Inventors: RC ANDERSON, LA MESA, CA (US); KENNETH J. LONG, LA MESA, CA (US)

(21) Appl. No.: 14/694,752

(22) Filed: Apr. 23, 2015

(51) Int. Cl. A42B 3/04; F21V 33/00; F21S 9/02

(52) U.S. Cl. CPC A42B 3/044; F21S 9/02; F21V 33/0008; F21W 2121/06

(57) ABSTRACT

A helmet light bar coupleable to a helmet includes a housing, a plurality of light-emitting modules associated with the housing, and a controller adapted to active one or more of the plurality of light-emitting modules responsive to either or both of a signal indicative of activation of emergency lights on a motor vehicle and a signal indicative of a level of intensity of deceleration of the motor vehicle.

### BACKGROUND

1. Technical Field

The present disclosure generally relates to high-visibility safety lights. More particularly, the present disclosure relates to a helmet light bar and a safety light system including the same to improve safety and reduce vehicle-related incidents related to response of vehicular-mounted officers, such as motorcycle-mounted police and highway patrol officers.

2. Discussion of Related Art

Motor vehicle accidents occur every day, resulting in varying degrees of injury or, too often, death. The costs of motor vehicle accidents include property damage, lost earnings, lost household production, medical costs, emergency services, travel delay, vocational rehabilitation, workplace costs, administrative and legal costs, pain and loss of life.

Municipalities have a major concern regarding the safety of their employees and/or affiliate organizations, such as law enforcement officers, and private citizens. The economic costs to employees and/or citizens and their families that result from motor vehicle accidents are in the billions of dollars annually according to the Rockefeller Institute. Municipalities are looking to mitigate this risk significantly, to reduce costs of associated lawsuits, by increasing their efforts to implement new and proper safety equipment that is not available today.

While it is beneficial that the highest emphasis be placed on safety and particularly safe vehicle operations and proper safety equipment for municipalities and law enforcement, proper equipment and safety procedures should be used to prevent injuries by all riders of motorcycles. The use of protective helmets can minimize the risk of death or permanent impairment. As is well known, a motorcycle helmet generally consists of rigid head covering to reduce the force of a direct blow to the skull, a crushable liner to dissipate deceleration forces, and a retention system consisting of a chin strap. The rigid head covering, which may be a stiff outer shell of fiberglass or thermoplastic, protects by its capacity to spread a concentrated load at its outer surface over a larger area of the liner and the wearer's head. The crushable liner (e.g., an energy-absorbing foam liner) protects the head from direct impact by its capacity to manage impact energy. Since there is no certain way to anticipate the severity of a head impact or whether the impact surface will be such that it will spread the load over the helmet or concentrate it at a single point, the most generally effective helmet will combine the strongest, stiffest possible outer shell with a liner chosen to limit the peak deceleration of the wearer's head to within tolerable limits.

Many crashes between motorists and motorcycles are a result of abrupt deceleration of a motorcycle which is not perceived by motorists trailing the motorcycle. There is a need to provide visual indication to motorists of how rapidly a motorcycle is decelerating, such that the risk of collision is more quickly perceived by the motorist. There is a need for the visual indication of deceleration to be effective day and night, so that accidents can be averted at all times.

The use of motorcycles and other motorized vehicles imposes risks of death or permanent impairment. The lack of visual indication of the deceleration of a motorcycle is a significant safety issue for all riders of motorcycles. There is a continuing need for proper safety equipment to improve safety and reduce vehicle-related incidents related to response of vehicular-mounted officers, such as motorcycle-mounted police and highway patrol officers, bicycle-mounted police officers, and horse-mounted police officers.

### SUMMARY

According to an aspect of the present disclosure, a helmet light bar coupleable to a helmet is provided. The helmet light bar includes a housing, a plurality of light-emitting modules associated with the housing, and a controller adapted to active one or more of the plurality of light-emitting modules responsive to either or both of a signal indicative of activation of emergency lights on a motor vehicle and a signal indicative of a level of intensity of deceleration of the motor vehicle.

According to another aspect of the present disclosure, a safety light system is provided. The safety light system includes: a base transmitter component communicatively coupleable with one or more system components of a motor vehicle; a helmet adapted to be wearable by a motor vehicle operator; and a helmet light bar attached to a rear portion of the helmet. The one or more system components include an emergency lights switch. The helmet light bar includes a housing, a plurality of independently controllable light-emitting modules associated with the housing, and a helmet receiver component. The helmet receiver component includes an antenna and a controller adapted to active one or more of the plurality of light-emitting modules responsive to either or both of a signal received from the base transmitter component indicative of activation of the emergency lights switch on the motor vehicle and a signal indicative of a level of intensity of deceleration of the motor vehicle.

### BRIEF DESCRIPTION OF THE DRAWINGS

Objects and features of the presently-disclosed helmet light bar and safety light system including the same will become apparent to those of ordinary skill in the art when descriptions of various embodiments thereof are read with reference to the accompanying drawings, of which:

FIG. 1 is a perspective view of a safety light system including a helmet light bar in accordance with an embodiment of the present disclosure;

FIG. 2 is an enlarged, perspective view of the helmet light bar of FIG. 1, showing multiple light-emitting modules associated with a housing of the helmet light bar, with electrical components contained within the housing shown in phantom lines, in accordance with an embodiment of the present disclosure;

FIG. 3 is a perspective view of a helmet including a rear portion adapted to mountingly receive the helmet light bar of the safety light system of FIG. 1 in accordance with an embodiment of the present disclosure

FIG. 4 is a perspective view of the helmet of FIG. 3 and the helmet light bar of FIG. 2 in an assembled configuration in accordance with an embodiment of the present disclosure;

FIG. 5 is a functional block diagram of a helmet receiver/emergency transmitter of the safety light system of FIG. 1 in accordance with an embodiment of the present disclosure;

FIG. 6 is perspective view of a printed circuit board including a microcontroller and an antenna for implementing the helmet receiver/emergency transmitter of FIG. 5 in accordance with an embodiment of the present disclosure;

FIG. 7 is a functional block diagram of a base transmitter/emergency receiver of the safety light system of FIG. 1 in accordance with an embodiment of the present disclosure;

FIG. 8 is perspective view of a printed circuit board including a microcontroller and an antenna for implementing the base transmitter/emergency receiver of FIG. 7 in accordance with an embodiment of the present disclosure;

FIG. 9 is a schematic diagram of microcontroller inputs/outputs of the base transmitter/emergency receiver of FIG. 8 in accordance with an embodiment of the present disclosure;

FIG. 10 is a schematic diagram of microcontroller inputs/outputs of the helmet receiver/emergency transmitter of FIG. 6 in accordance with an embodiment of the present disclosure;

FIG. 11 is a perspective view of an accelerometer component in accordance with an embodiment of the present disclosure;

FIGS. 12A-12C illustratively depict illumination of light-emitting diodes (LEDs) of first and second light-emitting modules of the helmet light bar of FIG. 2 in accordance with an embodiment of the present disclosure; and

FIGS. 13A-13C illustratively depict illumination of LEDs of a third light-emitting module of the helmet light bar of FIG. 2 in accordance with an embodiment of the present disclosure.

### DETAILED DESCRIPTION

Hereinafter, embodiments of a helmet light bar and a safety light system including the same are described with reference to the accompanying drawings. Like reference numerals may refer to similar or identical elements throughout the description of the figures.

This description may use the phrases “in an embodiment,” “in embodiments,” “in some embodiments,” or “in other embodiments,” which may each refer to one or more of the same or different embodiments in accordance with the present disclosure.

As it is used in this description, “portable power source” refers to any portable source of electrical power, e.g., battery or battery pack, portable solar power system, etc. As it is used in this description, “transmission line” generally refers to any transmission medium that can be used for the propagation of signals from one point to another. A transmission line may be, for example, a wire, two or more conductors separated by an insulating medium (two-wire, coaxial, microstrip, etc.), a waveguide, a fiber optic line and/or fiber optic bundles.

As it is used in this description, “printed circuit board” (or “PCB”) generally refers to systems that provide, among other things, mechanical support to electrical devices and/or components, electrical connection to and between these electrical components, combinations thereof, and the like. As used herein, the term “controller” may include any type of computing device, computational circuit, or any type of processor or processing circuit capable of executing a series of instructions that are stored in a memory associated with the controller.

As it is used in this description, “light-emitting diode” generally refers to any light source that is capable of receiving an electrical signal and producing a color of light in response to the signal. Thus, “light-emitting diode,” as used herein, includes any light source including but not limited to light-emitting diodes (LEDs) of all types, including white LEDs, infrared LEDs, ultraviolet LEDs, visible color LEDs, light-emitting polymers, semiconductor dies that produce light in response to current, organic LEDs, electro-luminescent strips, silicon based structures that emit light, and other such light sources. As it is used in this description, “color” generally refers to any frequency of electromagnetic radiation, or combination of different frequencies, within the visible light spectrum, the infrared and ultraviolet areas of the spectrum, and in other areas of the electromagnetic spectrum where illumination sources may generate radiation.

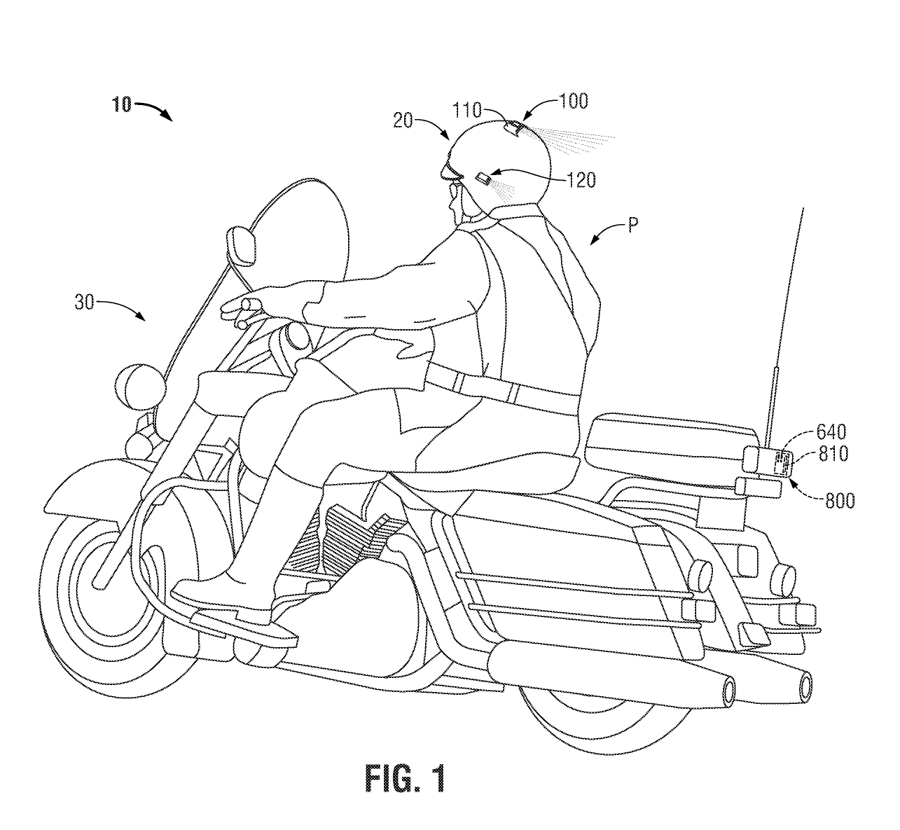

Various embodiments of the present disclosure provide a safety light system (generally shown as 10 in FIG. 1) including a helmet receiver/emergency transmitter operably associated with a helmet light bar attached to a helmet, wearable by an operator of a motorcycle (or bicycle, powered bicycle, etc.), and a base transmitter/emergency receiver operably associated with the motorcycle. The base transmitter/emergency receiver (also referred to herein as the “base transmitter component”) includes a controller configured to receive one or more signals from one or more sensors, buttons, and/or switches associated with the motorcycle, e.g., one or more switches associated with the motorcycle light module. The helmet receiver/emergency transmitter (also referred to herein as the “helmet receiver component”) includes a controller configured to transmit one or more signals for activating one or more light sources, e.g., light-emitting modules, associated with a housing of the helmet light bar.

The controller associated with the helmet receiver component may include logic, circuitry and/or code adapted to control one or more light-emitting modules (e.g., composed of LEDs, LED tape lighting, LED light strips, fiber optic lighting, chemical lighting, lasers, etc.) for providing police emergency lights (e.g., blue and/or amber lights), e.g., responsive to one or more signals received from the base transmitter component and/or one or more signals from one or more sensors, buttons, and/or switches associated with the helmet. In some embodiments, the controller associated with the helmet receiver component may additionally, or alternatively, include logic, circuitry and/or code adapted to control a light-emitting module for providing a red brake light (e.g., a red light of varying intensity depending on deceleration force), e.g., responsive to one or more signals received from the base transmitter component and/or one or more signals from one or more sensors, buttons, and/or switches associated with the helmet.

FIG. 1 shows a safety light system 10 that includes a helmet light bar 100 in accordance with an embodiment of the present disclosure. The safety light system 10 includes a base transmitter component 800 operably associated with a motorcycle 30. The base transmitter component 800 (also referred to herein as “base transmitter/emergency receiver 800”) includes an antenna 810, and may include an accelerometer 640. Those skilled in the art will recognize that the location of the base transmitter component 800 may be varied from the configuration depicted in FIG. 1.

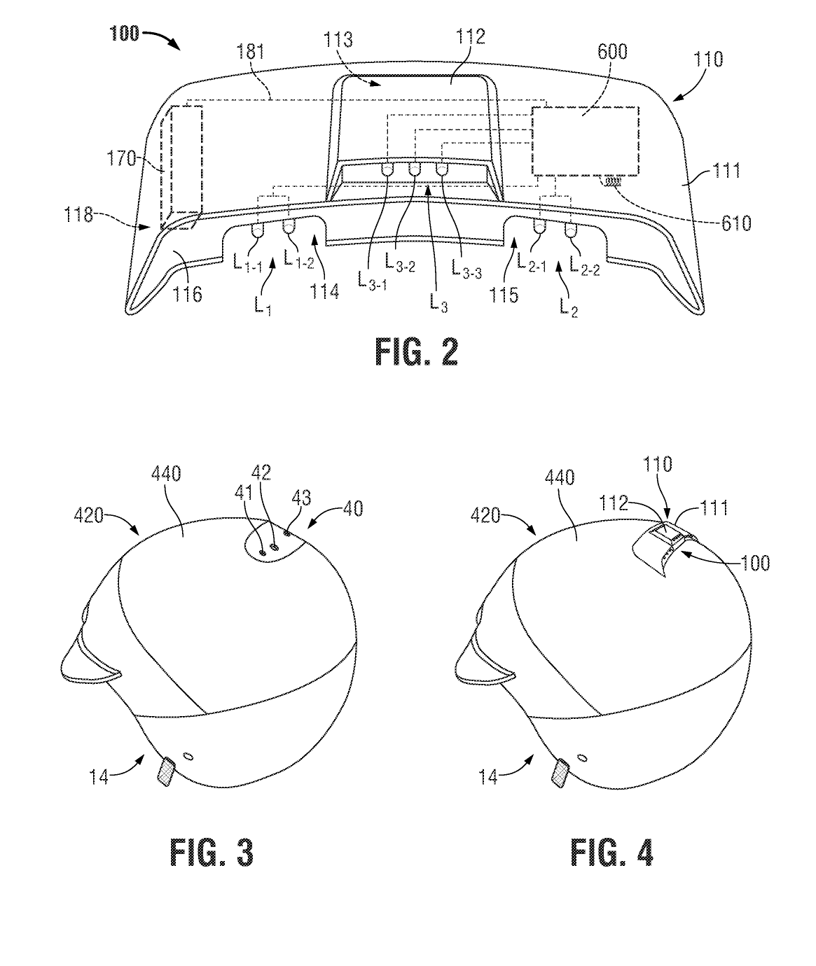

As described in more detail below, the helmet light bar 100 includes a plurality of light sources, e.g., light-emitting modules, associated with a housing 110 of the helmet light bar 100. A helmet receiver component 600 (shown in FIGS. 2 and 6) is contained within the housing 110. In the illustrative embodiment shown in FIG. 1, the helmet light bar 100 is attached to a helmet 20, wearable by an operator “P” of the motorcycle 30. The size, shape and location of the helmet light bar 100 may be varied from the configuration depicted in FIG. 1. In some embodiments, as shown for example in FIG. 1, the safety light system 10 includes an alternate light source 120 associated with the helmet 20. The helmet light bar 100 (and/or alternate light source 120) may be retrofit to the helmet or incorporated directly into the helmet. The alternate light source 120 may include one or more lighting devices (e.g., LEDs, flexible LED strip lights, LED tape, fiber optic lighting, chemical lighting, lasers, etc.). In some embodiments, a plurality of alternate light sources 120 may be employed at different locations, e.g., front, left-side, right-side, and/or rear portion of a helmet (e.g., helmet 20 shown in FIG. 1, or helmet 420 shown in FIGS. 3 and 4).

Referring now to FIG. 2, the housing 110 of the helmet light bar 100 includes a body portion 111 and an upper portion 112 coupled to the body portion 111. In some embodiments, the body portion 111 and the upper portion 112 are integrally formed as a single unitary body by a suitable molding process, such as injection molding. In other embodiments, the upper portion 112 may be formed as a separate component. The upper portion 112 may be configured to be selectively detachable and attachable to the body portion 111, e.g., to facilitate removal and/or replacement of a light-emitting module. The upper portion 112 and the body portion 111 may be assembled together with the aid of alignment pins, detents, snap-like interfaces, tongue and groove interfaces, locking tabs, adhesive ports, etc., utilized either alone or in combination for assembly purposes. Any suitable joining method may be used to attach (or clip, connect, couple, fasten, secure, etc.) the upper portion 112 to the body portion 111.

The body portion 111 includes a portion 116 defining a first opening 114 and a second opening 115. The helmet light bar 100 includes two, selectively activatable light-emitting modules individually associated with the first opening 114 and the second opening 115. The light-emitting modules associated with the first opening 114 and a second opening 115 may be implemented as LED modules. In the illustrative embodiment shown in FIG. 2, the helmet light bar 100 includes a first LED module L₁, an second LED module L₂, and a third LED module L₃. Preferably, both of the first and second LED modules L₁ and L₂ consist of one, two, three or four individual LEDs and the third LED module L₃ consists of one, two, three, four, five, six or seven individual LEDs. In an embodiment, the first LED module L₁ includes first and second LEDs L₁₋₁ and L₁₋₂, and the second LED module L₂ includes first and second LEDs L₂₋₁ and L₂₋₂. The first and second LEDs L₁₋₁ and L₁₋₂ of the first LED module L₁ and the first and second LEDs L₂₋₁ and L₂₋₂ of the second LED module L₂ may be any color of LED, e.g., amber or blue. Those skilled in the art will recognize that LED color, luminous intensity, and color changing pattern may be dictated by federal, state and/or local laws. The first and second LEDs L₁₋₁ and L₁₋₂ of the first LED module L₁ and/or the first and second LEDs L₂₋₁ and L₂₋₂ of the second LED module L₂ may be color-changeable LEDs and/or the intensity of the LED illumination may be controllable.

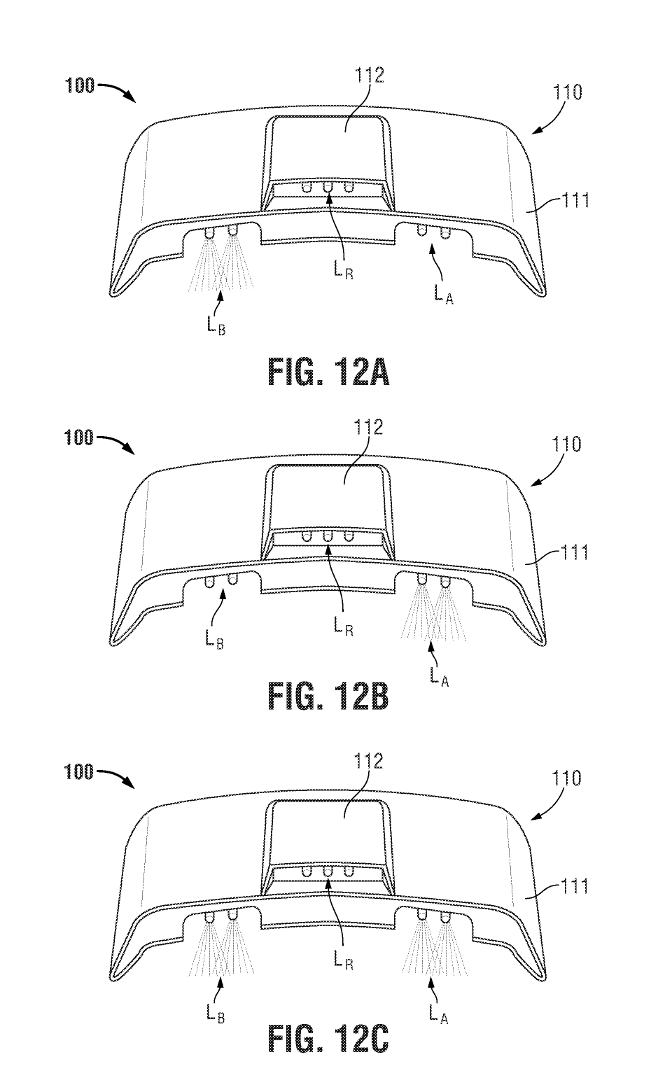

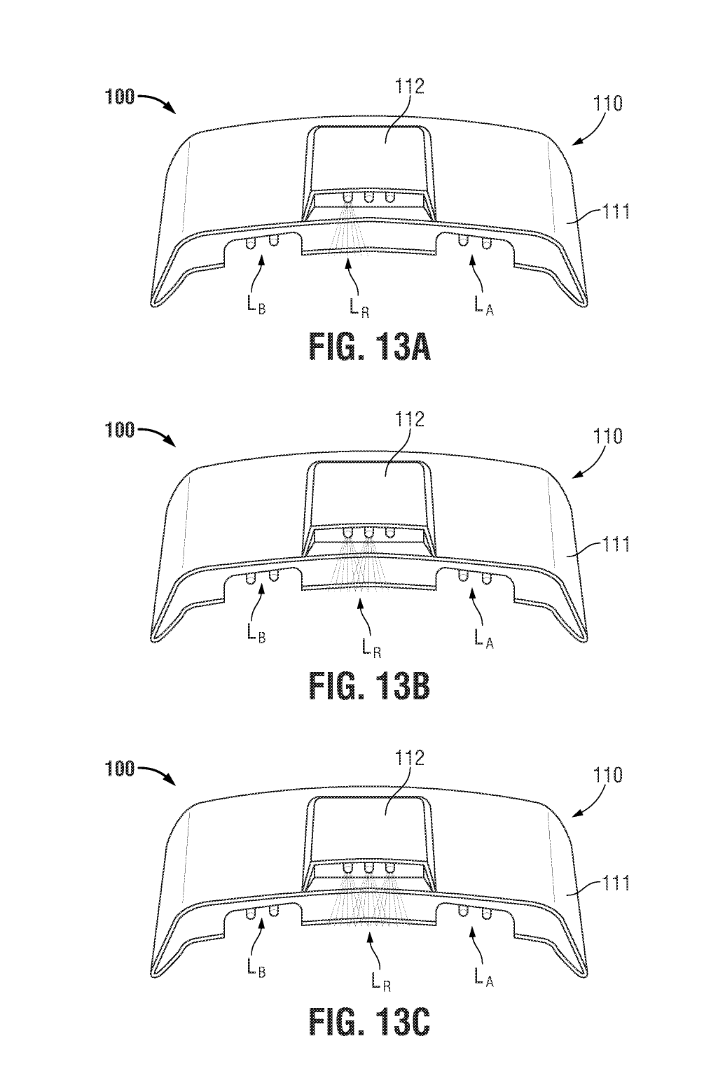

In an illustrative embodiment, the first LED module L₁ may be composed of blue LEDs (e.g., as indicated by “L_{B}” in FIGS. 12A-12C and 13A-13C) and the second LED module L₂ may be composed of amber LEDs (e.g., as indicated by “L_{A}” in FIGS. 12A-12C and 13A-13C). In other embodiments, the first and second LEDs L₁₋₁ and L₁₋₂ of the first LED module L₁ may be blue and amber (or amber and blue), respectively, and the first and second LEDs L₂₋₁ and L₂₋₂ of the second LED module L₂ may be blue and amber (or amber and blue), respectively. The size, shape, and number of LEDs of the first and second LED modules L₁ and L₂ may be varied from the configuration depicted in FIG. 2.

In some embodiments, as shown for example in FIG. 2, the third LED module L₃ includes first, second and third LEDs L₃₋₁, L₃₋₂ and L₃₋₃. The third LED module L₃ may be composed of red LEDs (e.g., as indicated by “L_{R}” in FIGS. 12A-12C and 13A-13C). The first, second and third LEDs L₃₋₁, L₃₋₂ and L₃₋₂ of the third LED module L₃ may be color-changeable LEDs and/or the intensity of the LED illumination may be controllable. Those skilled in the art will recognize that other configurations of LEDs (and/or other light sources) are contemplated.

A portable power source 170 is contained with a cavity 118 defined by the body portion 111. Preferably the portable power source 170 is a rechargeable battery or battery pack. In the preferred embodiment, the portable power source 170 is a lithium-ion polymer battery. Those skilled in the art will recognize that other portable power sources are contemplated.

As seen in FIG. 2, the helmet receiver component 600 (also referred to herein as “helmet receiver/emergency transmitter 600”) is housed within the cavity 118 of the body portion 111. The helmet receiver component 600 is electrically coupled via a transmission line 181 to the portable power source 170. The helmet receiver component 600 includes an antenna 610 used for communication with the base transmitter component 800 (shown in FIGS. 1 and 8). As described in more detail below, the helmet receiver component 600 is adapted to control activation of the first LED module L₁, the second LED module L₂, and the third LED module L₃. It is to be understood that the dashed lines indicative of electrical connections (e.g., electrical conductors) between various components of the helmet light bar 100 are merely illustrative and non-limiting examples of electrical connections, and that helmet light bar embodiments of the present disclosure may utilize many different configurations of electrical connections, some with additional, fewer, or different electrical connections than depicted in FIG. 2.

FIG. 3 shows a helmet 420 including a rear portion 40 adapted to mountingly receive the helmet light bar 100 of the safety light system 10. The helmet 420 may be a hard-shell, impact absorbing helmet which preferably provides a user with resistance to head injury due to impact when properly utilized. The helmet 420 generally consists of a shell 440 constructed of a rigid material. The shell 440 may preferably be contoured and includes a bottom opening 14 such that the shell 440 is configured to fit over the head of a user.

The rear portion 40 of the helmet 420 is provided with a plurality of apertures, e.g., to facilitate attachment of the helmet light bar 100. In the illustrative embodiment shown in FIG. 3, the rear portion 40 includes two apertures 41 and 43 having a first diameter arranged on opposing sides of an aperture 42 having a second diameter. The second diameter may be larger than the first diameter. As seen in FIG. 3, the three circular apertures 41, 42 and 43 are arranged so as to form a single line. Those skilled in the art will recognize that other arrangements of one or more apertures are contemplated. One or more apertures may additionally, or alternatively, be provided to facilitate the attachment of one or more alternate light sources 120.

FIG. 4 shows the helmet light bar 100 assembled together with the helmet 420. The helmet light bar 100 may be retrofit to the helmet 420 or incorporated directly into the helmet 420. The helmet light bar 100 and the helmet 420 may be assembled together with the aid of alignment pins, detents, snap-like interfaces, tongue and groove interfaces, locking tabs, adhesive ports, etc., utilized either alone or in combination for assembly purposes. Any suitable joining method may be used to attach (or clip, connect, couple, fasten, secure, etc.) the helmet light bar 100 to the helmet 420. The helmet light bar 100 may be permanently attached, or releasably fastened, to the helmet 420.

In an embodiment, the body portion 111 of the helmet light bar 100 is provided with two alignment pins (not shown) configured to engage with the apertures 41 and 43 on the rear portion 40 of the helmet 420. Additionally, or alternatively, a threaded fastener (not shown) may be employed to detachably threadedly engage with the aperture 42 on the rear portion 40 of the helmet 420 for attachment of the helmet light bar 100 to the helmet 420.

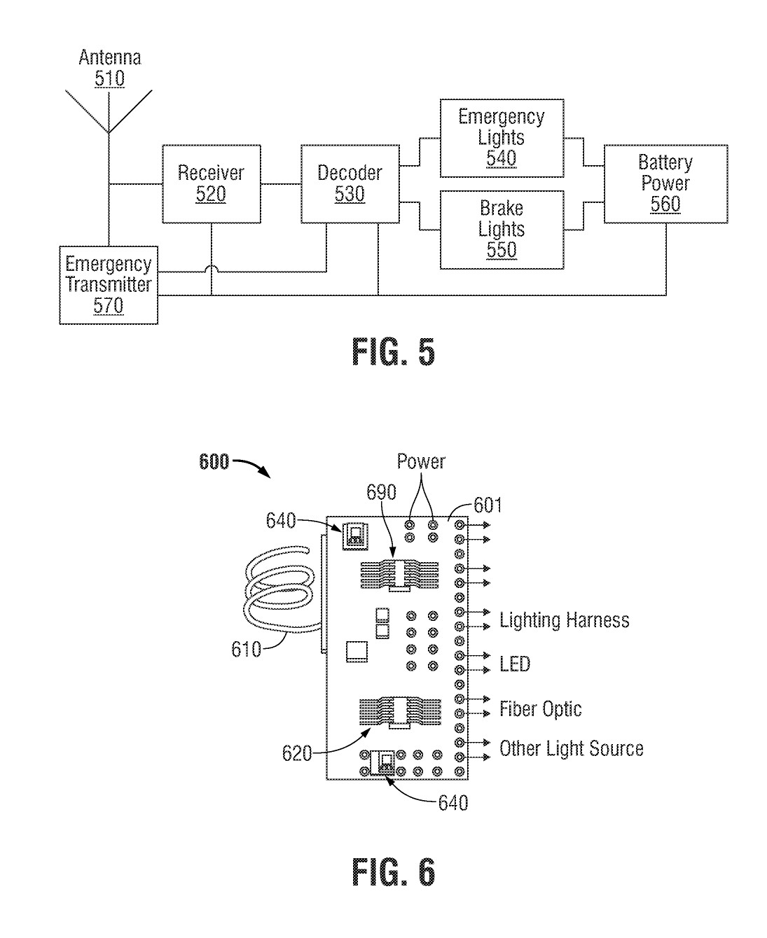

Referring now to FIG. 5, the helmet receiver component 600 of the safety light system 10 may be functionally divided into the six components: receiver 520; decoder 530; emergency lights 540; brake lights 550; battery power 560; and emergency transmitter 570. The receiver 520 accepts signals from the antenna 510 and then routes the signals to the decoder 530. Using power from the battery power 560, the decoder 530 decodes the input signals from the receiver 520 (and/or the emergency transmitter 570) and outputs one or more signals to the emergency lights 540 and/or the brake lights 550. Those skilled in the art will recognize that the functionality shown in FIG. 5 may be implemented in one or more electronic components.

Printed circuit boards (PCBs) are generally used to mechanically support and electrically connect electronic components using electrically-conductive pathways or signal traces that conduct signals on the PCB. PCBs may be classified as single-sided PCBs, double-sided PCBs, and multilayer PCBs, according to the number of circuit pattern surfaces. In addition to a pattern of conductive traces on the PCB, a patterned array of metal-filled through-holes, or vias, may be formed to allow for layer-to-layer interconnections among various conductive features. PCBs may be classified as rigid or flexible. Flexible PCBs may save weight and space compared to rigid PCBs. Depending on the electronic components and circuitry required to implement the functionality shown in FIG. 5, the physical characteristics (e.g., size, shape and thickness) of the PCB must be designed to fit the available space in the cavity 118 defined by the body portion 111 of the housing 110.

FIG. 6 shows a PCB 601 with an antenna 610 in accordance with an embodiment of the present disclosure. PCB 601 includes a microcontroller 620 for implementing functions of the helmet receiver component 600, and a programmable lighting sequencer 690 operably coupled to the microcontroller 620. In some embodiments, the helmet receiver component 600 includes an accelerometer 640. Additionally, or alternatively, the base transmitter component 800 (shown in FIGS. 1 and 8) may include an accelerometer 640.

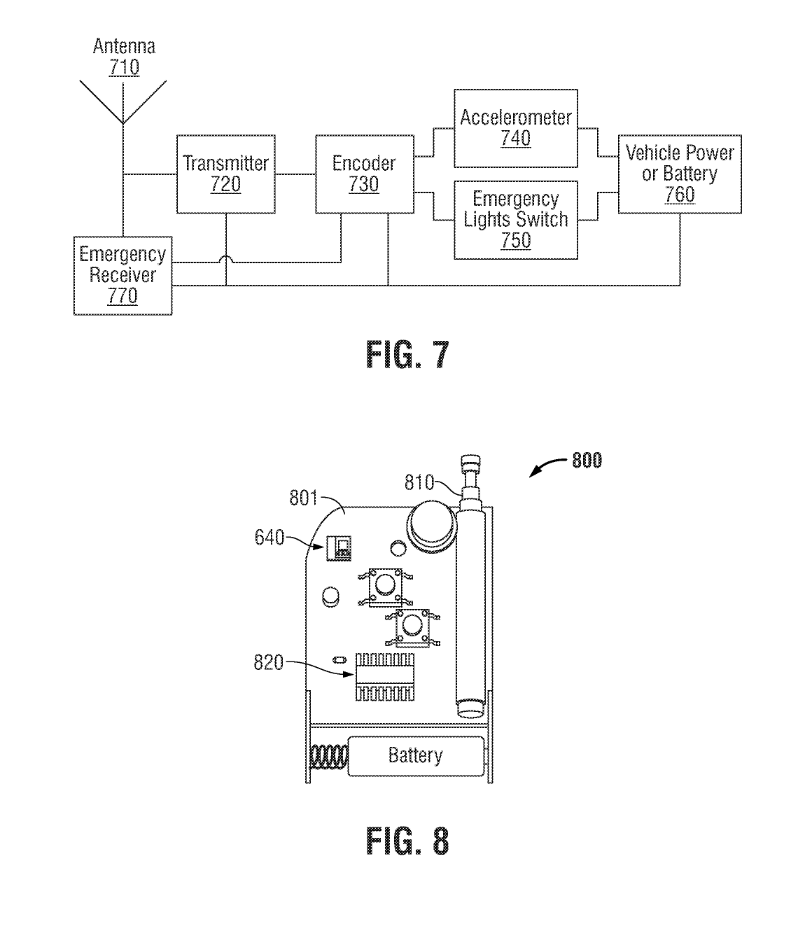

Referring now to FIG. 7, the base transmitter component 800 of the safety light system 10 may be functionally divided into the six components shown in FIG. 7. The components are transmitter 720, encoder 730, accelerometer 740, emergency light switch 750, vehicle power or battery 760, and emergency receiver 770. Using power from the vehicle power or battery 760, the encoder 730 encodes signals from the emergency receiver 770, the accelerometer 740 and/or the emergency light switch 750, and routes the signals to the transmitter 720. Using power from the vehicle power or battery 760, the transmitter 720 sends the signals via the antenna 710.

FIG. 8 shows a printed circuit board 801 including an antenna 810 and a microcontroller 820 for implementing functions of the base transmitter component 800 in accordance with an embodiment of the present disclosure. As seen in FIG. 8, a battery is provided as a power source for the microcontroller 820. In the illustrative embodiment shown in FIG. 8, the base transmitter component 800 includes an accelerometer 640.

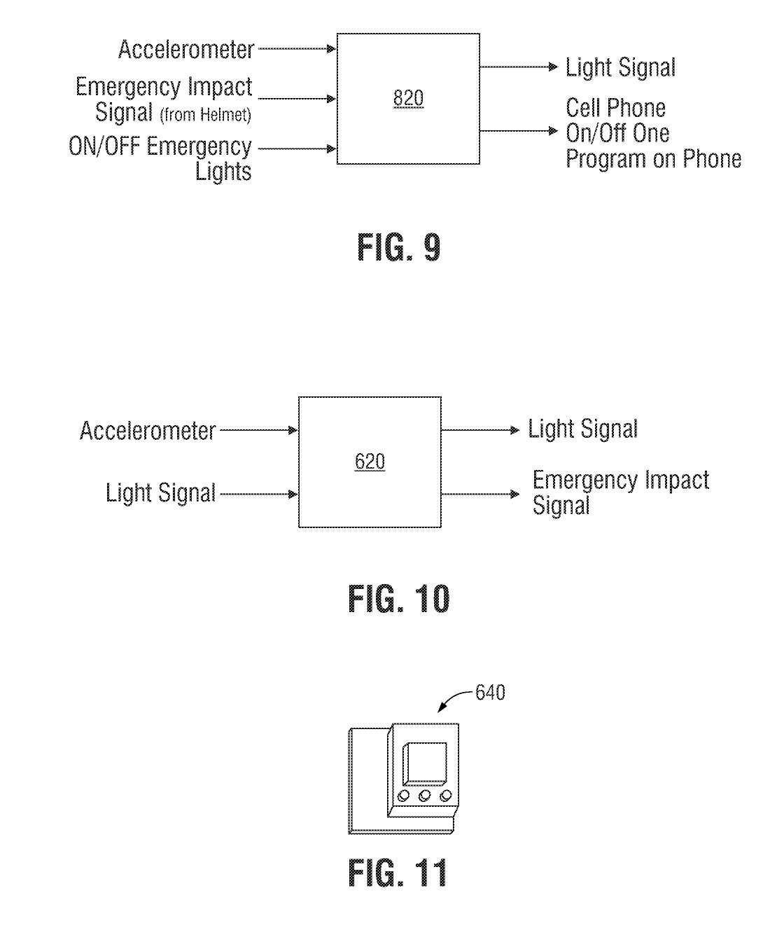

FIG. 9 schematically illustrates the microcontroller 820 inputs and outputs in accordance with an embodiment of the present disclosure. The microcontroller 820 is configured to receive signals from an accelerometer (e.g., accelerometer 640 shown in FIG. 8), an emergency impact signal received from the helmet receiver component 600, and a signal indicative of ON/OFF emergency lights, e.g., operated by the operator “P” of the motorcycle 30 shown in FIG. 1. The microcontroller 820 is configured to output signals for activation of one or more light sources (e.g., one or more light-emitting modules and/or alternate light sources 120 of the helmet light bar 100). The microcontroller 820 may additionally be configured to output signals for activation/deactivation of a cellular phone.

As is well known, during collisions, motorcycles are rapidly decelerated due to the impact forces. In some embodiments, the helmet receiver component 600 (and/or the base transmitter component 800) includes an accelerometer 640. The accelerometer 640 may be used to detect rapid deceleration that is indicative of a collision and desirably the microcontroller 820 may be configured to activate a cellular phone (and/or other communication device) to send an alert. Additionally, or alternatively, the microcontroller 820 may be configured to activate emergency flashers and/or deactivate the fuel supply system on the motorcycle in the event of such a collision. Additionally, or alternatively, the microcontroller 820 may be configured to receive an emergency impact signal from the helmet and/or the helmet light bar 100.

FIG. 10 schematically illustrates the microcontroller 620 inputs and outputs in accordance with an embodiment of the present disclosure. The microcontroller 620 is configured to receive signals from an accelerometer (e.g., accelerometer 640 shown in FIG. 6) and light-activation signals from the base transmitter component 800. The microcontroller 620 is configured to output signals to the programmable lighting sequencer 690 (and/or to one or more light-emitting modules of the helmet light bar 100), in response to the light-activation signals received from the base transmitter component 800 (e.g., signal indicative of ON/OFF emergency lights, “all on” light signal, and/or brake light intensity signal). In some embodiments, the microcontroller 620 may be configured to output an emergency impact signal responsive to signals received from the accelerometer 640.

In FIG. 11, the accelerometer 640 is shown. The accelerometer 640 is an electronic component designed to measure pitch, role and shock. These are measured using the changes in the x-axis and y-axis. The accelerometer 640 may be any device capable of generating a signal that is indicative of the acceleration/deceleration of the motorcycle 30. The safety light system 10 may be configured to generate a brake light intensity signal (e.g., to activate red lights on the helmet light bar 100) based on the signal from the accelerometer 640. The safety light system 10 may additionally, or alternatively, be configured to send an emergency signal to activate a cellular phone and/or to activate an “all on” light signal (e.g., to activate emergency lights on the motorcycle 30 and/or flashing lights on the helmet light bar 100) in response to the signal from the accelerometer 640. In some embodiments, the accelerometer 640 may be configured to measure and record the forces during deceleration indicative of an impact.

During operation of the safety light system 10, using power from a portable power source 170 the helmet receiver component 600 intercepts commands from the base transmitter component 800 causing the helmet receiver component 600 to perform one of its functions. The helmet receiver component 600 then turns on the emergency lights 540 or activates the brake lights 550. In some embodiments, the helmet receiver component 600 may activate a blue LED module L_{B} to illuminate first and second blue LEDs as shown in FIG. 12A and/or activate an amber LED module L_{A} to illuminate first and second amber LEDs as shown in FIG. 12B. The blue LED module L_{B} and the amber LED module L_{A} may be alternatingly activated in a flashing fashion, and/or activated simultaneously as shown in FIG. 11C. Additionally, or alternatively, the helmet receiver component 600 may activate the third LED module L₃ (e.g., red LED module L_{R} shown in FIGS. 13A-13C) as described in more detail below. In some embodiments, the helmet receiver component 600 is adapted to be capable of sending signals to the base transmitter component 800.

The microcontroller 620 of the helmet receiver component 600 may activate either of both of the first LED module L₁ and the second LED module L₂ in a flashing manner in response to a signal indicative of the activation of emergency lights (e.g., switch ON) on a motor vehicle (e.g., motorcycle 30 shown in FIG. 1). In an illustrative example, which is described in terms of the functional elements shown in FIGS. 5 and 7) an operator P of the motorcycle 30 activates the emergency light switch 750 (e.g., toggles a switch, depresses a button, etc.) which sends a signal to the encoder 730. Using power from the vehicle power or battery 760, the encoder 730 outputs a signal indicative of the emergency lights activation to the transmitter 720. The transmitter 720 sends the signal via the antenna 710. The receiver 520 receives the signal from the antenna 510 and then routes the signal to the decoder 530. The decoder 530 outputs one or more signals to the activate either of both of the first LED module L₁ and the second LED module L₂.

Referring now to FIGS. 13A-13C, the first red LED R₁, the second red LED R₂, and the third red LED R₃ of the third LED module L_{R} of the helmet light bar 100 may be selectively activated by the helmet receiver component 600, responsive to one or more signals received from the base transmitter component 800 and/or one or more signals from the accelerometer 640 associated with helmet light bar 100 (and/or the helmet 420). In an illustrative example, the accelerometer 740 measures the deceleration (e.g., rate of deceleration or pressure on brake) and sends one or more signals indicative of the level of intensity to the encoder 730. Using power from the vehicle power or battery 760, the encoder 730 encodes the signals from the accelerometer 740 and routes the signals to the transmitter 720. The transmitter 720 sends the signals via the antenna 710. The receiver 520 receives the signal from the antenna 510 and then routes the signal to the decoder 530. The decoder 530 outputs one or more signals to activate the first red LED R₁, the second red LED R₂, and/or the third red LED R₃ of the third LED module L_{R}. Preferably, the luminous intensities are two to three lumens (“low” intensity), five to seven lumens (“medium” intensity), and eight to twelve lumens (“high” intensity). Those skilled in the art will recognize that the sequencing, luminous intensity, and number of lights sources (e.g., LEDs) may be varied depending on various factors, such as for example, regional requirements, government agency requirements, federal, state, or local laws, etc.

In an illustrative embodiment, the first red LED R₁ may be activated during light deceleration of the motorcycle 30 to generate “low” intensity illumination of the third LED module L_{R}, as illustratively depicted in FIG. 13A, the first and second red LEDs R₁ and R₂ may be activated during down shifting, entering a curve, and/or general high speed maneuvering to generate “medium” intensity illumination of the third LED module L_{R}, as illustratively depicted in FIG. 13B, and the first, second and third red LEDs R₁, R₂ and R₃ may be activated during full braking of the motorcycle 30 to generate “high” intensity illumination of the third LED module L_{R}, as illustratively depicted in FIG. 13C.

Although embodiments have been described in detail with reference to the accompanying drawings for the purpose of illustration and description, it is to be understood that the disclosed processes and apparatus are not to be construed as limited thereby. It will be apparent to those of ordinary skill in the art that various modifications to the foregoing embodiments may be made without departing from the scope of the disclosure.

What is claimed is:

1. A helmet light bar coupleable to a helmet, the helmet wearable by an operator of a motor vehicle, the helmet light bar comprising:
a housing;
a plurality of light-emitting modules associated with the housing;
a controller adapted to activate one or more of the plurality of light-emitting modules responsive to either or both of a signal indicative of activation of emergency lights on the motor vehicle and a signal indicative of a level of intensity of deceleration of the motor vehicle.

2. The helmet light bar of claim 1, wherein the housing is adapted to be coupleable to the helmet.

3. The helmet light bar of claim 1, wherein the housing includes a body portion and an upper portion, wherein the upper portion is adapted to be selectively detachable from the body portion.

4. The helmet light bar of claim 3, further comprising a portable power source, wherein the controller is electrically coupled to the portable power source.

5. The helmet light bar of claim 4, wherein the body portion of the housing defines a cavity therein configured to house the portable power source.

6. The helmet light bar of claim 1, wherein the plurality of light-emitting modules includes a first light-emitting diode (LED) module including first and second blue LEDs.

7. The helmet light bar of claim 6, wherein the plurality of light-emitting modules further includes a second LED module including first and second amber LEDs.

8. The helmet light bar of claim 7, wherein the plurality of light-emitting modules further includes a third LED module including first, second and third red LEDs.

9. A safety light system, comprising:
a base transmitter component communicatively coupleable with one or more system components of a motor vehicle, wherein the one or more system components include an emergency lights switch;
a helmet adapted to be wearable by a motor vehicle operator;
a helmet light bar attached to a rear portion of the helmet, wherein the helmet light bar includes:
a housing;
a plurality of independently controllable light-emitting modules associated with the housing; and
a helmet receiver component, wherein the helmet receiver component includes:
an antenna and a controller adapted to active one or more of the plurality of light-emitting modules responsive to either or both of a signal received from the base transmitter component indicative of activation of the emergency lights switch on the motor vehicle and a signal indicative of a level of intensity of deceleration of the motor vehicle.

10. The safety light system of claim 9, wherein the plurality of light-emitting modules includes a first light-emitting diode (LED) module including first and second blue LEDs.

11. The safety light system of claim 10, wherein the plurality of light-emitting modules further includes a second LED module including first and second amber LEDs.

12. The safety light system of claim 11, wherein the plurality of light-emitting modules further includes a third LED module including first, second and third red LEDs.

13. The safety light system of claim 9, wherein the helmet light bar further includes a portable power source, and wherein the controller is electrically coupled to the portable power source.

14. The safety light system of claim 13, wherein the housing includes a body portion, the body portion defining a cavity therein configured to house the portable power source.

15. The safety light system of claim 14, wherein the helmet receiver component is contained within said cavity.

16. The safety light system of claim 14, wherein the housing further includes an upper portion adapted to be selectively detachable from the body portion.

17. The safety light system of claim 16, wherein at least one of the plurality of light-emitting modules is associated with the upper portion of the housing.
